(19) United States
(12) Patent Application Publication
(10) Pub. No.: US 2023/0331529 A1
(43) Pub. Date: Oct. 19, 2023

(54) METHOD AND DEVICE FOR PREPARING A BEVERAGE

(71) Applicant: SOCIETE DES PRODUITS NESTLE S.A., Vevey (CH)

(72) Inventors: ERIC GABRIEL MARCHAL, Vittel (FR); FRANCOIS PREVOTAT, Verrieres le Buisson (FR)

(21) Appl. No.: 17/907,143

(22) PCT Filed: Mar. 29, 2021
(86) PCT No.: PCT/EP2021/058085

§ 371 Date: Sep. 23, 2022

(30) Foreign Application Priority Data
Mar. 30, 2020 (EP) 20166611.2

(51) Int. Cl. B67D 1/00; B67D 1/08

(52) U.S. Cl. CPC B67D 1/0036; B67D 1/0888

(57) ABSTRACT

The present invention relates to a method (1) for preparing a beverage by dispensing a defined amount of a beverage product (10) over a defined time, the method (1) comprising: •—starting the dispensing of the beverage product by dispensing water (2) during the defined time such that a defined amount of water (2) is dispensed over the defined time, •—at the start of the dispensing of the water (2), starting dispensing at least one flavor product (4) so as to reach a defined amount of the at least one flavor product (4) by the end of a defined adjunction time, said defined adjunction time being equal to or smaller than the defined time, and •—during the dispensing of the water (2), starting dispensing at least one additive (6) so as to reach a defined amount of the at least one additive (6) at the end of the defined adjunction time.

### FIELD OF THE INVENTION

The present invention relates to a method and a device for the preparation of a beverage, preferably a water based beverage, by dispensing a defined amount of a beverage product to be drunk by a consumer. The present invention may be used to prepare a wide spectrum of beverages. Such beverages are usually composed of water and a flavor product, like flavor or aroma, etc. Such beverages may be further be composed of an additive that can produce a short-term effect on the consumer, like caffeine.

### TECHNICAL BACKGROUND

In order to prepare such beverages, known beverage preparation methods and devices start mixing the beverage components and dispense the beverage product soon after the preparation of the beverage as started. Thus, all of the ingredients, e.g. water, the flavor product and the additive start being mixed dispensed at the same time, which is when the beverage preparation begins. In some known beverage preparation devices, the recipe of a beverage may be selected by the consumer using specific commands, for example by selecting the proportion of sugar or sweetener, the quantity of flavor product, etc.

However, the known beverage preparation methods present the following problems and drawbacks. The present applicant has noticed that a consumer often likes to first try a sample of a beverage recipe before ordering the full beverage or that the consumer is not patient enough to wait for the final delivery of the full beverage. The consumer then interrupts the beverage preparation either by stopping the dispensing process or by withdrawing its cup or glass from below the dispensing outlet. At this point, the consumer can drink the beverage sample, which already contains a certain amount of the additive. Then, the consumer may order a full beverage according to the same beverage recipe or try another beverage sample until the consumer finds a pleasing recipe or just keep the beverage in a non-finalized state and dink it.

In so doing, the consumer will accumulate a certain intake of the additive over a certain period. But the additive may be subject to a daily recommendation intake, because an excessive intake of such additive or an intake of highly concentrated portion of such additive may induce some undesirable effect or even worth some undesirable health issues. Hence, it can be desirable to provide a beverage preparation method or device enabling limiting or even minimizing the additive intake by the consumer and providing the additive in an acceptable concentration whatever the moment the consumer stops the delivery of the beverage intentionally or not.

### SUMMARY OF THE INVENTION

In view of the above-mentioned problems and drawbacks, the present invention aims to improve the current implementations. An objective is to provide a device that may prepare beverages with beverage additive(s) having little or no preservatives. The objective is achieved by the embodiments defined in the independent claims. Advantageous implementations are further defined in the dependent claims.

An embodiment of the invention provides a method for the preparation of a beverage by dispensing a defined amount of a beverage product over a defined time, the method comprising at least:
starting the dispensing of the beverage product by dispensing water during the defined time such that a defined amount of water is dispensed over the defined time,
at the start of the dispensing of the water, starting dispensing at least one flavor product so as to reach a defined amount of the at least one flavor product by the end of a defined adjunction time, said defined adjunction time being equal to or smaller than the defined time, and
during the dispensing of the water, starting dispensing at least one additive so as to reach a defined amount of the at least one additive at the end of the defined adjunction time.

Thus, the method enables a consumer to taste various recipes/take off its cup before the end of the delivery of the full beverage, while limiting or even minimizing the additive intake and concentration of the additive intake by the consumer. Indeed, the dispensing of the additive is made over the complete adjunction time and/or deferred up until the latest possible time for completing the full dispensing of the defined amount of beverage product over the defined time. This, latest possible time may be set in various manners, for example predetermined, selected, or calculated.

In particular, there may be an initial period where no additive is dispensed, depending on the defined amount of the beverage product and the respective flow rates of water and of the additive. So when the consumer interrupts the beverage preparation, the consumer may taste the beverage sample with no or little intake of an additive that is subject to a disclaimer, like caffeine for example. Further, the beverage sample may have a taste similar or close to the taste expected for the complete beverage and/or at least an acceptable taste.

The proposed method allows controlling the concentration of additive in the beverage along its dispensing so as to avoid any possible undesirable effect or undesirable health issue of a high concentration of said additive in the beverage if the consumer stop the dispensing or take off its cup from the dispensing device.

In particular, the additive may be subject to a regulation by a food or health administration and or to a specific disclaimer to be applied (based on regulation for example). The recommendation or, as the case may be, the regulation or the disclaimer which the additive is subject to may differ from one country to the other and from one substance to the other. For example, depending on the country legislation, a disclaimer has to be presented for the delivering of additives like caffeine or green tea extract.

In particular, when the beverage preparation is interrupted before the dispensing of the additive starts, the beverage product normally comprises water and a flavor product but no additive. When the beverage preparation is not interrupted before the dispensing of the additive starts, the beverage product normally comprises water, a flavor product and more or less additive.

The delivery of the additive is made such that if the beverage preparation is interrupted before the end of the full delivery, the concentration of the additive, on to which a disclaimer applies, is acceptable in terms of taste and does not bring undesirable effect or undesirable health issues.

In the present disclosure, the term “time” may refer either to a period of time, i.e. having a relatively long duration, or to a point in time. When referring to a point in time in the present disclosure, the term “time” may refer to an instant or to a moment having a relatively short duration of e.g. a few seconds, say of 2 seconds. In the present disclosure, the expression “by the end of the defined time” may be interpreted with the common meaning of “at or before the end of the defined time”.

Likewise, the term “at” may refer to an instant or to a moment having a relatively short duration of e.g. a few seconds, say of 2 seconds. For example, the expression “at the start of the dispensing of the water” may mean at the instant of the start or upon the start i.e. immediately after the start. As a further example, the expression “at the end of the defined time” may mean at the instant of the end or shortly before the end.

The defined adjunction time is defined as being equal to or smaller than the defined time. When the defined adjunction time is smaller than the defined time, it is comprised between 85 to 98% of the defined time.

In some implementations, water may be dispensed continuously over the defined time (preferred). Alternatively, water may be dispensed intermittently over the defined time. In some implementations, the flow rate of water may be substantially constant, for example constant. Alternatively, the flow rate of water may be variable.

In some implementations, the flavor product may be dispensed continuously within the defined adjunction time (preferred). Alternatively, the flavor product may be dispensed intermittently within the defined adjunction time. In some implementations, the flow rate of the flavor product may be substantially constant, for example constant. Alternatively, the flow rate of the flavor product may be variable.

In some implementations, the additive may be dispensed continuously within the defined adjunction time (preferred). Alternatively, the additive may be dispensed intermittently within the defined adjunction time. In some implementations, the flow rate of the additive may be substantially constant, for example constant. Alternatively, the flow rate of the additive may be variable.

In some implementations, the dispensing of the flavor product may start “at” the start of the dispensing of the water. Thus, the dispensing of the flavor product and the dispensing of water start simultaneously or almost simultaneously. Alternatively, the dispensing of the flavor product may start “upon” the start of the dispensing of the water, i.e. within a few seconds, say 1 or 2 seconds, after the start of the dispensing of water.

In some implementations, the flavor product may be a flavor or an aroma, for example orange, peach, lemon, ginger, etc. In some implementations, the additive may be a tea extract or a coffee extract like caffeine, or a “functional enhancer”, which produces a short-term effect on the consumer. For example, the additive may be a probiotic, a prophylactic, a vitamin, caffeine or another coffee or tea extract.

In various implementations, the method may further comprise: during the dispensing of the water, starting dispensing an additional additive so as to reach a defined amount of the additional additive by the end of the defined time.

Thus, the additional additive may provide additional benefits to the consumer, for example taste, organoleptic, or health enhancements.

In various implementations, the dispensing of the additional additive may be started after, preferably immediately after, the defined amount of the flavor product has been dispensed.

Thus, when the beverage preparation is interrupted before the dispensing of the additional additive starts, the beverage product normally comprises water and a flavor product but no additional additive. This may prevent that the additional additive influences the taste of the beverage sample.

In various implementations, the additional additive may not be subject to a disclaimer for example on daily intake. The additional additive may be for example selected in the group comprising: minerals, mineral solution, mineral liquid concentrate, fruit juice, fruit extract, plant or vegetable juice or extract, vitamins and any combination thereof

Thus, the additional additive may be dispensed any time without risking inducing any undesirable health issues or without important effect on the taste of the beverage.

In a preferred embodiment, a rinsing step is proposed after the delivery of the flavor product, of the additive and of the additional additive. During the rinsing step, only water is dispensed inside the dispensing nozzle of the corresponding dispensing device allowing to limit the carryover of flavor, additive or additional additive between two servings.

In a proposed implementation, at the end of the dispensing of the flavor product and/or at the end of the dispensing of the additive and/or at the end of the dispensing of the additional additive, the remaining amount of the water to be dispensed is at least 2 to 15% of the defined amount of water to be dispensed. With the defined remaining water to be dispense, the rinsing is efficient.

In some implementations, the weight ratio of the additional additive over the complete beverage product may have very different depending on the additional additive. For example, it will be very different if the additional additive is a mineral or a fruit juice.

In various implementations, the additive may be subject to a disclaimer, for example on daily intake or in relation to a specific state, the additive (6) being for example selected in the group comprising: caffeine, green tea extract, taurine, plant or vegetable ingredients, plant or vegetable extracts, probiotics, prebiotics, vitamins, and any combination thereof.

This is the case for the delivery of caffeine for which a disclaimer will appear on the screen of the dispensing device with a focus attention on children, on pregnant women and on the daily intake.

In some proposed implementation, the additive may produce a short-term effect on the consumer, like caffeine, green tea extract or taurine.

In various implementations, a flow rate of the water may be higher than the respective flow rates of the flavor product, the additive and, if present, the additional additive, preferably 5 to 20 times higher, more preferred 10 to 15 times higher.

Thus, the dilution of the flavor product and of the additive and, if any, of the additional additive may be sufficient.

The respective flow rate of the flowable product, e.g. of water, flavor product, additive or additional additive, may be measured when said flowable product is being dispensed.

In various implementations, the flavor product, the additive and, if present, the additional additive may get dispensed at substantially the same flow rate.

Thus, the device for implementing the beverage preparation method may be built with similar elements for the dispensing of the flavor product as for the additive and the additional additive as the case may be.

The term “substantially the same flow rate” means that the difference between two flow rates is below 10%.

In various implementations, the water may be dispensed at a first defined flow rate, preferably between 10 and 100 mL/s, more preferably between 20 and 50 mL/s, most preferably between 25 and 35 mL/s, and/or
wherein the flavor product may be dispensed at a second defined flow rate, preferably between 0.5 and 20 mL/s, more preferably between 1-10 mL/s, most preferably between 2 and 5 mL/s, and/or
wherein the additive may be dispensed at a third defined flow rate, preferably between 0.5 and 20 mL/s, more preferably between 1 and 10 mL/s, most preferably between 2 and 5 mL/s, and/or
wherein the additional additive, if present, may be dispensed at a fourth defined flow rate, preferably between 0.5 and 20 mL/s, more preferably between 1 and 10 mL/s, most preferably between 2 and 5 mL/s.

Thus, the defined amount of the beverage product may be fully dispensed in a relatively short defined time.

In various implementations, the beverage preparation may be interruptable, preferably upon a request of a consumer, at any time during the defined time.

Thus, the consumer may taste a beverage sample corresponding to the expected taste with the selected recipe.

A further embodiment of the invention provides a device for the preparation of a beverage by dispensing a defined amount of a beverage product over a defined time, the device comprising:
a dispensing section for dispensing a beverage product,
a water supply for supplying water to the dispensing section, preferably at a first defined flow rate,
a flavor supply for dispensing a flavor product to the dispensing section, preferably at a second defined flow rate,
an additive supply for dispensing an additive to the dispensing section, preferably at a third defined flow rate, and
a control unit configured:
   to start the dispensing of the beverage product by dispensing water during the defined time such that a defined amount of water is dispensed over the defined time,
   during the dispensing of the water, to start dispensing at least one flavor product so as to reach a defined amount of the at least one flavor product by the end of a defined adjunction time, said defined adjunction time being equal to or smaller than the defined time preferably, the adjunction time is comprised between 85 to 98% of the defined time, and
   during the dispensing of the water (2), to start dispensing at least one additive (6) so as to reach a defined amount of the at least one additive (6) by the end of the defined adjunction time.

Thus, the device enables limiting or even minimizing the additive intake by the consumer and providing the additive in an acceptable concentration whatever the moment the consumer stops the delivery of the beverage intentionally or not.

Indeed, in the proposed implementations the dispensing of the additive is made over the complete adjunction time and/or is deferred up until the latest possible time for completing the full dispensing of the defined amount of beverage product over the defined time. In particular, there may be an initial period where no additive is dispensed, depending on the defined amount of the beverage product and the respective flow rates of water and of the additive. So when the consumer interrupts the beverage preparation, the consumer may taste the beverage sample with no or little intake of an additive that is subject to a disclaimer, for example on daily intake, like caffeine. Further, the beverage sample may have a taste similar or close to the taste expected for the complete beverage.

The proposed device allows controlling the concentration of additive in the beverage along its dispensing so as to avoid any possible undesirable effect or undesirable health issue of a high concentration of said additive in the beverage if the consumer stop the dispensing or take off its cup from the dispensing device.

In particular, the additive may be subject to a regulation by a food or health administration and or to a specific disclaimer to be applied (based on regulation for example). The recommendation or, as the case may be, the regulation or the disclaimer which the additive is subject to may differ from one country to the other and from one substance to the other. For example, depending on the country legislation, a disclaimer has to be presented for the delivering of additives like caffeine or green tea extract.

In particular, when the beverage preparation is interrupted before the dispensing of the additive starts, the beverage product normally comprises water and a flavor product but no additive. When the beverage preparation is not interrupted before the dispensing of the additive starts, the beverage product normally comprises water, a flavor product and more or less additive.

The delivery of the additive is made such that if the beverage preparation is interrupted before the end of the full delivery, the concentration of the additive, on to which a disclaimer applies, is acceptable in terms of taste and does not bring undesirable effect or undesirable health issues.

In various implementations, the control unit may be further configured to, during the dispensing of the water, start dispensing an additional additive so as to reach a defined amount of the additional additive by the end of the defined time, the control unit being preferably configured to start the dispensing of the additional additive after, preferably immediately after, the defined amount of the flavor product has been dispensed.

Thus, the control unit may control the preparation of a beverage product or of a beverage sample thereof. For example, the control unit may control the device to implement a method as disclosed above.

In various implementations, the additional additive may not subject to a disclaimer, for example on daily intake, the additional additive being for example selected in the group comprising: minerals, mineral solution, mineral liquid concentrate, fruit juice, fruit extract, plant or vegetable juice or extract, vitamins and any combination thereof.

In various implementations, the additive may not be subject to a disclaimer, for example on daily intake or in relation to a specific state, the additive being for example selected in the group comprising: caffeine, green tea extract, taurine, plant or vegetable ingredients, plant or vegetable extracts, probiotics, prebiotics, vitamins, and any combination thereof.

Thus, the additional additive may be dispensed any time or along the full defined adjunction time without risking inducing any undesirable health issues. Besides, the additive may produce a short-term effect on the consumer, like caffeine.

In various implementations, the device may further comprise at least one pump for delivering to the dispensing section the water, the flavor product, the additive, and, if present, the additional additive, preferably at a fourth defined flow rate.

Thus, the components of the beverage may be delivered to the dispensing section so as to dispense the beverage product or a beverage sample thereof.

In various implementations, the flavor product, and/or the additive, and/or, if present, the additional additive may be stored in containers, preferably replaceable containers, and most preferably in bag-in-boxes or Tetra-Pack®. Thus, an empty container may be quickly replaced.

Preferably the flavor product, and/or the additive, and/or, if present, the additional additive are stored in the form of concentrates so that a small amount of the flavor product/additive/additional additive is necessary for the preparation of the beverage product.

In a preferred implementation, the additive is stored in the container at a limited concentration in and the delivery of the additive is preferably made all along the defined adjunction time or on an end period of the defined adjunction time.

The concentration of the additive in the container and the delivery sequence of the additive are calculated so as to avoid any risk for the consumer in case the additive container is positioned in place of a flavor container or an additional additive container.

In various implementations, the containers may carry readable data, like product information, preferably as a code, and the device may comprise a reader, preferably a code reader, configured to read the readable data for example RFID reader, preferably upon positioning of the container proximate or in the device, and preferably the control unit may be configured to receive and use the readable data read for controlling that the container is in the correct slot and is accurate for example in terms of expiry date, genuine product . . . and that the preparation of a beverage can be authorized.

Thus, the containers may quickly be identified, and their presence may be displayed on a consumer graphical interface, for example on a touchscreen for enabling the consumer to order a beverage.

It has to be noted that all devices, elements, components, members, units and means described in the present application could be implemented in any technically applicable combination of the embodiments and implementations. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in any technically applicable combination of the embodiments and implementations.

### BRIEF DESCRIPTION OF DRAWINGS

The above described aspects and implementation forms of the present invention will be explained in the following description of specific embodiments and aspects in relation to the enclosed drawings, in which:

FIG. 1 is a schematic bar graph over time illustrating a method according to a first embodiment of the invention;

FIG. 2 is a schematic bar graph over time illustrating a method according to a second embodiment of the invention; and

FIG. 3 is a schematic perspective exploded view of a device according to an embodiment of the invention.

### DETAILED DESCRIPTION

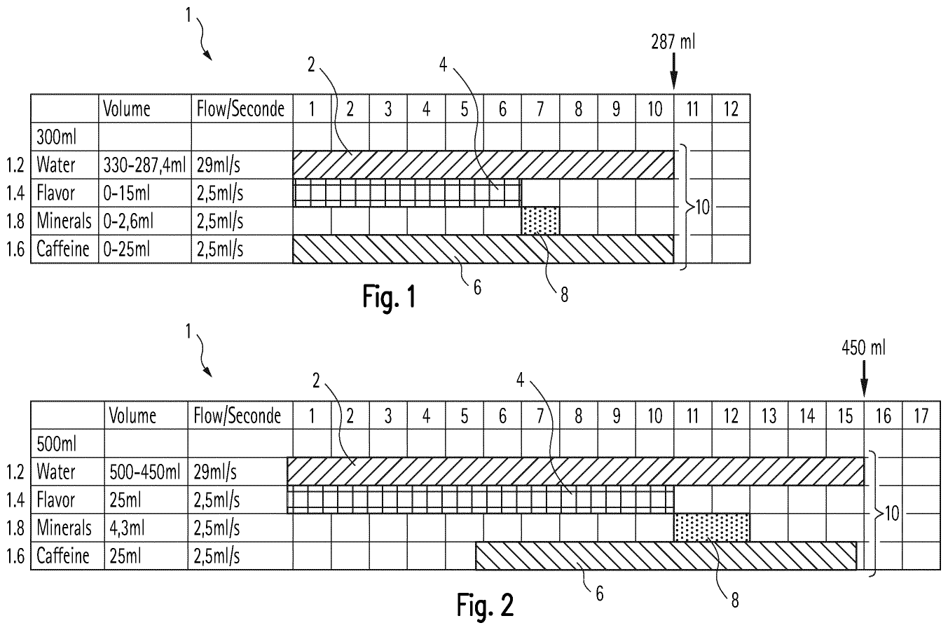

FIG. 1 illustrates a method 1 according to a first embodiment for the preparation of a beverage 10 by dispensing a defined amount of a beverage product over a defined time.

The numbers 1-12 in the top line of the bar chart represent the number of seconds that have elapsed after the method 1 has started being performed. In the example of FIG. 1 the defined time, during which the method 1 may be performed, may be about 10 s depending on the volume the consumer may have selected. In a defined time of 10 s a defined amount (volume) of about 287 mL of water may be dispensed, which corresponds to a final volume of 330 mL of beverage (including the water, the flavors, the additives, additional additives).

In the example of FIG. 1 the leftmost column indicates various components of the beverage product, herein water, a flavor product, caffeine as an additive and minerals as an additional additive. The second leftmost column indicates the respective volumes of these beverage components in accordance with a recipe, which may be predetermined or selected by a consumer. The third leftmost column indicates the respective flow rates of the beverage components during performing of the method 1.

At the beginning, the method 1 comprises starting the dispensing of the beverage product by dispensing water 2 (step 1.2; first bar from the top) during the defined time of 10 s, such that a defined amount of water 2 is dispensed over the defined time of 10 s.

Then, the method 1 comprises, at the start of the dispensing of the water, herein at 0 s, starting dispensing the flavor product 4 (step 1.4; second bar from the top) so as to reach a defined amount of the flavor product 4 by the end of the defined time of 10 s.

Then, the method 1 comprises, during the dispensing of the water 2 (1.2; first bar), starting dispensing an additive 6 (step 1.6; bottom bar; caffeine), herein at 0 s, so as to reach a defined amount of the additive at the end of the defined time of 10 s. In the example of FIG. 1 the defined amount of the additive 6 may be 25 mL. The dispensing of the defined amount (25 mL) of the additive 6 may span the whole defined time of 10 s. The additive 6 may be subject to a disclaimer for a maximum daily intake or directed to specific persons.

For example, if the additive 6 is caffeine as presented in the present embodiment, a disclaimer will appear on the screen of the dispensing device for pregnant women or children and presenting a warning on daily intake.

As an example, for caffeine, the total amount of caffeine that is dispensed is 75 mg per serving i.e. 75 mg in a volume of 25 mL of additive.

Water may be dispensed continuously over the defined time of 10 s. The defined flow rate of water 2 may be substantially constant, at about 29 mL/s, apart maybe from a short initial transition phase and a short final transition phase. The flow rate of water 2 may be about 11 times higher than the respective flow rates of the flavor product 4 and the additive 6, which may all get dispensed at substantially the same defined flow rate, herein about 2.5 mL/s.

The flavor product 4 may be dispensed continuously within the defined adjunction time of s, which in the present embodiment is similar to the defined time. The flow rate of the flavor product 4 may be substantially constant, at about 2.5 mL/s, apart maybe from a short initial transition phase and a short final transition phase. The additive 6 (caffeine) may be dispensed continuously within the defined adjunction time of 10 s. The defined flow rate of the additive 6 may be substantially constant, at about 2.5 mL/s, apart maybe from a short initial transition phase and a short final transition phase.

The beverage preparation according to the method 1 may be interruptable, hence possibly interrupted, upon a request of a consumer at any time during the defined time of 10 s. or if, for example, the consumer withdraw the cup or glass from below the dispenser outlet. Thus, the consumer may taste a beverage sample having an acceptable taste that could be considered as similar to the expected taste with the selected recipe. In such a case, the consumer may taste the beverage sample with little intake of the additive 6, herein caffeine. The resulting beverage sample may have a taste similar to the taste expected for the complete beverage, i.e. the beverage product 10 dispensed without interruption.

The proposed dispensing sequence allows preserving the safety of the consumer when an additive 6 having a functional effect and/or is delivered.

In the method 1, the dispensing of the flavor product 4 may start at the start of the dispensing of the water 2. Thus, the dispensing of the flavor product 4 and the dispensing of water 2 start simultaneously or almost simultaneously at 0 s.

The method 1 may further comprise: during the dispensing of water 2 (1.2; first bar), starting dispensing of an additional additive 8 (step 1.8; third bar from top; minerals) so as to reach a defined amount (about 2.6 mL) of the additional additive 8 by the end, herein before the end, of the defined time of 10 s. The additional additive 8 may not be subject to a disclaimer, for example on daily intake.

The dispensing of the additional additive 8 may be started immediately after, herein at about 6 s, the defined amount (15 mL) of the flavor product 4 has been dispensed. The dispensing of the additional additive 8 may herein last for 1 s. The weight ratio of the additional additive 8 over the complete beverage product 10 may be about 0.8%.

Thus, when the beverage preparation is interrupted before the dispensing of the additional additive 8 starts, the beverage product normally comprises water and a flavor product but no additional additive 8. This may prevent that the additional additive 8 influences the taste of the beverage sample.

FIG. 2 illustrates a method 1 according to a second embodiment. Inasmuch as the method 1 of FIG. 2 is similar to the method 1 of FIG. 1, the afore-detailed description may be applied to the method 1 of FIG. 2, except for the hereafter-mentioned noticeable differences. An element of the method 1 of FIG. 2 having a structure or function identical or similar to an element of the method 1 of FIG. 1 is given the same reference sign.

FIG. 2 illustrates a method 1 according to a second embodiment for the preparation of a beverage by dispensing a defined amount of a beverage product 10 over a defined time. FIG. 2 is similar to FIG. 1, in particular in that the method 1 of FIG. 2 produces a beverage product 10 having the same beverage components as in the method 1 of FIG. 1, namely water 2, a flavor product 4, an additive 6 (caffeine) and an additional additive 8 (minerals). The beverage components in the method 1 of FIG. 2 are dispensed at similar respective flow rates as in the method 1 of FIG. 1. The defined amount of the additive 6 (caffeine) may be 25 mL in the method 1 of FIG. 2 like in the method 1 of FIG. 1.

The method 1 of FIG. 2 differs from the method 1 of FIG. 1 in particular because the defined time for dispensing the beverage is different, the defined adjunction time for dispensing the flavor, additives and additional additive is different from the defined time and the defined amount of beverage product 10 is different. In the method 1 of FIG. 2 the defined time, during which the method of FIG. 2 may be performed, may be about 15 s, depending on the volume considered as a local preference or that the consumer may have selected. In a defined time of 15 s a defined amount of about 450 mL of water 2 may be dispensed, which corresponds to a final beverage volume of about 500 mL.

The method 1 of FIG. 2 further differs from the method 1 of FIG. 1 because the dispensing of the defined amount (25 mL) of the additive 6 does not span the whole defined time of 15 s. Indeed, firstly, the dispensing of the additive 6 only starts at about 5 s in the example of FIG. 2, whereas the dispensing of the additive 6 starts at about 0 s in the example of FIG. 1 and secondly, the additive 6 is dispensed over a defined adjunction time that is different from the defined time.

So the dispensing of the additive 6 in the example of FIG. 2 may span a period of time of 10 s, which may run from an instant at 5 s to an instant at 14.75 s, i.e. before the end of the defined time that is 15 s. In this period of time lasting a bit less than 10 s, the volume of 25 mL of additive 6 may be reached.

Thus, if a consumer interrupts the method of FIG. 2 before the dispensing of the additive 6 has started, i.e. before the instant at 5 s, the beverage product normally comprises water 2 and the flavor product 4 but no additive 6. So the consumer may taste the recipe of FIG. 2, while minimizing its additive intake.

Additionally, the fact that the delivery of the flavor, additive and additional additive ends at a defined adjunction time ending prior to the end of the water dispensing (defined time) allows to have a rinsing step. During the rinsing step, only water is dispensed inside the dispensing nozzle of the corresponding dispensing device allowing to limit the carryover of flavor, additive or additional additive between two servings.

To allow a efficient rinsing, the remaining amount of the water to be dispensed may be between 2 to 15% of the defined amount of water to be dispensed.

The method 1 of FIG. 2 also differs from the method 1 of FIG. 1 because a higher defined amount (4.3 mL vs. 2.5 mL) of the additional additive 8 (minerals) is dispensed in the beverage product 10.

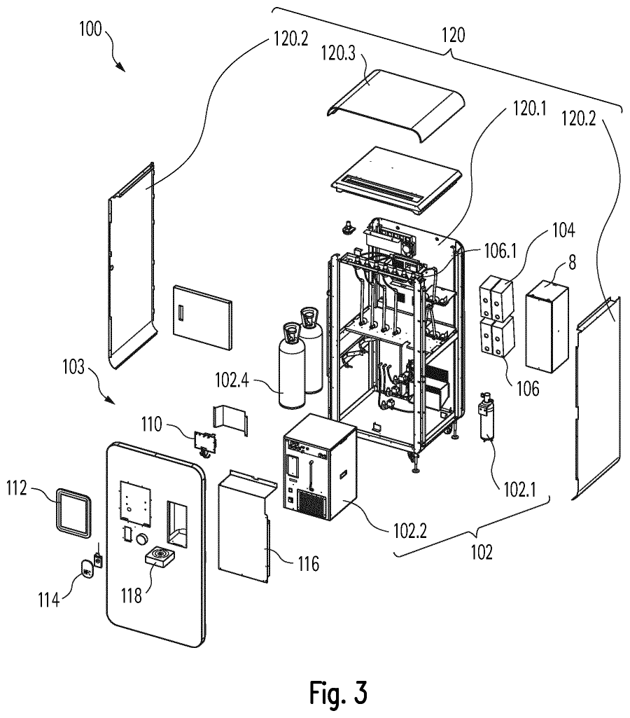

FIG. 3 illustrates a device 100 for the preparation of a beverage by dispensing a defined amount of a beverage product 10 over a defined time. The device 100 comprises:
a dispensing section 103 for dispensing a beverage product,
a water supply 102 for supplying water to the dispensing section 103,
a flavor supply 104 for dispensing a flavor product to the dispensing section 103,
an additive supply 106 for dispensing an additive to the dispensing section 103, and
a control unit 110.

The control unit 110 is configured:
to start the dispensing of the beverage product 10 by dispensing 1.2 water 2 during the defined time such that a defined amount of water is dispensed over the defined time,
at the start of the dispensing of the water, to start dispensing a flavor product so as to reach a defined amount of the flavor product by the end of the defined time, and
during the dispensing of the water, to start dispensing an additive so as to reach a defined amount of the additive at the end of the defined time.

So the control unit 110 may be configured to, during the dispensing of the water 2, start dispensing an additional additive 8 so as to reach a defined amount of the additional additive 8 by the end of the defined time. The control unit 110 may be configured to start dispensing the additional additive 8 immediately after the defined amount of the flavor product 8 has been dispensed. Thus, the control unit 110 may control the preparation of a beverage product 10 or of a beverage sample thereof in accordance with a method 1 as described in relation to FIG. 1-2.

The device 101 may further comprise a display 112, a payment interface 114, a protection panel 116 behind the front wall, and a drip tray 118 configured for supporting the user's cup while the beverage preparation section 103 dispenses the prepared beverage. The control unit 110 may convey information to the user via the display 112.

The user may place an order for a beverage via the display 112, which may be a graphical user interface including a touchscreen, and pay via the payment interface 114. Upon a consumer's selection, the control unit 110 may control the beverage preparation section 103 to prepare and dispense the ordered beverage in accordance with a method 1 as described in relation to FIG. 1-2.

The device 1 may further comprise a housing 120 for housing the beverage preparation section 103, the water supply 102, and the additive supply 106. The housing 120 may comprise a frame 120.1, side walls 120.2, and a top wall 120.3 fastened to the frame 120.1.

The beverage preparation section 103 is configured to prepare and dispense a beverage product. The water supply 102 is configured to supply water to the beverage preparation section 103 for the preparation of a beverage. The water supply 102 and the beverage preparation section 103 may be fluidly connected by a non-illustrated water duct. The water duct may comprise at least one pipe, tube, hose or channel.

The device 1 may further comprise at least one pump for delivering to the dispensing section 103 the water 2, the flavor product 4, the additive 6, and, if present, the additional additive 8, preferably at a defined flow rate. With such pump(s) the components of the beverage may be delivered to the dispensing section 103 so as to dispense the beverage product 10 or a beverage sample thereof into the consumer's cup or glass.

In the example of FIG. 3, the water supply 102 may comprise a non-illustrated water pump configured for supplying water to the beverage preparation section 103. The water supply 102 may further comprise a water filter 102.1 for filtering the water, for example between the water pump and the beverage preparation section 103. The water supply 102 may be fluidly connected to a non-illustrated water distribution network.

The additive supply 106 is configured to supply an additive (e.g. caffeine) and, if any, an additional additive (minerals) to the beverage preparation section 103. The additive may be mixed with water from the water supply 102 for preparing a beverage. The additive supply 106 and the beverage preparation section 103 may be fluidly connected by one or more non-illustrated additive duct(s). The additive ducts may comprise at least one pipe, tube, hose or channel.

The additive supply 106 may comprise additive pumps 106.1 configured for supplying the additive, preferably in a fluidic state, to the beverage preparation section 103. Each additive pump 106.1 may be a peristaltic pump configured to compress a respective additive duct, which is a compressible hose in this variant. In the example of FIG. 1, the additive supply 106 may comprise four additive pumps 106.1.

The flavor product, and/or the additive, and/or, if present, the additional additive may be stored in containers. The additive supply 106 comprises a storage section for storing four containers. The containers may be bag-in-boxes, one of which may contain the additive and another one the additional additive.

The containers may carry, for example on an outer side, non-illustrated readable data encoding product information as a code, e.g. a smartcode. The device 101 may comprise a non-illustrated reader configured to read the readable data, for example upon positioning of the container in the device 101. Once identified, the presence of the containers may be displayed on the display 112 for enabling the consumer to order a beverage. The control unit 110 may be configured to receive and use the readable data read for controlling the preparation of a beverage in accordance with a method 1 described above in relation to FIG. 1-2.

The storage section may be designed to receive the containers in a tilted orientation in order to facilitate the dispensing of the beverage additives respectively carried by the containers. In an assembled state, the containers may be located in the storage section between the additive ducts and the side wall 120.2 that is arranged at the rear of the device 101.

The water supply 102 may comprise a water cooling section 102.2 configured for cooling water to be delivered to the beverage preparation section 103. The water supply 102 may supply still water and sparkling, carbonated water. The water supply 102 may comprise one or more cylinders 102.4 containing CO2 for carbonating water. In the example of FIG. 3, the water cooling section 102.2 may include a separate chiller. The water cooling section 102.2 may comprise a compressor and a condenser to handle a cooling medium.

The beverage preparation section 103 may comprise a non-illustrated mixing chamber, which may comprise a non-illustrated dispensing outlet for dispensing the beverage product. The beverage preparation section 103 may be configured for preparing a beverage by mixing:
i) the water 2 supplied by the water supply 102,
ii) the additive 6 supplied by the additive supply 106, and/or
iii) the additional additive 8 supplied by the additive supply 106.

The present invention has been described in conjunction with various embodiments and implementations as examples. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims.

1. Method for the preparation of a beverage by dispensing a defined amount of a beverage product over a defined time, the method comprising at least:
starting the dispensing of the beverage product by dispensing water during the defined time such that a defined amount of water is dispensed over the defined time,
at the start of the dispensing of the water, starting dispensing at least one flavor product so as to reach a defined amount of the at least one flavor product by the end of a defined adjunction time, said defined adjunction time being equal to or smaller than the defined time, and
during the dispensing of the water, starting dispensing at least one additive so as to reach a defined amount of the at least one additive at the end of the defined adjunction time.

2. Method according to claim 1, wherein it further comprises, during the dispensing of the water, starting dispensing at least one additional additive so as to reach a defined amount of the at least one additional additive by the end of the defined adjunction time.

3. Method according to claim 1, wherein the dispensing of the additional additive is started after, preferably immediately after, the defined amount of the flavor product has been dispensed.

4. Method according to claim 1, wherein, when the defined adjunction time is smaller than the defined time, the defined adjunction time is comprised between 85 to 98% of the defined time

5. Method according to claim 3, wherein at the end of the dispensing of the flavor product and at the end of the dispensing of the additive, the remaining amount of the water to be dispensed is at least 2 to 15% of the defined amount of water to be dispensed thereby defining a rinsing step.

6. Method according to claim 2, wherein the additional additive is selected from the group consisting of: minerals, mineral solution, mineral liquid concentrate, fruit juice, fruit extract, plant, vegetable juice, extract, vitamins and any combinations thereof.

7. Method according to claim 1, wherein the additive is selected from the group consisting of: caffeine, green tea extract, taurine, plant, vegetable ingredients, plant or vegetable extracts, probiotics, prebiotics, vitamins, and any combination thereof.

8. Method according to claim 1, wherein a flow rate of the water is higher than the respective flow rates of the flavor product, and the additive.

9. Method according to claim 1, wherein the flavor product and the additive are dispensed at substantially the same flow rate.

10. Method according to claim 1, wherein the water is dispensed at a first defined flow rate, and
wherein the flavor product is dispensed at a second defined flow rate.

11. Device for the preparation a beverage by dispensing a defined amount of a beverage product over a defined time, the device comprising:
a dispensing section for dispensing a beverage product,
a water supply for supplying water to the dispensing section,
a flavor supply for dispensing a flavor product to the dispensing section,
an additive supply for dispensing an additive to the dispensing section, and
a control unit configured:
to start the dispensing of the beverage product by dispensing water during the defined time such that a defined amount of water is dispensed over the defined time,
during the dispensing of the water, to start dispensing at least one flavor product so as to reach a defined amount of the at least one flavor product by the end of a defined adjunction time, said defined adjunction time being equal to or smaller than the defined time, and
during the dispensing of the water, to start dispensing at least one additive-so as to reach a defined amount of the at least one additive by the end of the defined adjunction time.

12. Device according to claim 11, wherein the control unit is further configured to, during the dispensing of the water, start dispensing at least one additional additive so as to reach a defined amount of the additional additive by the end of the defined adjunction time.

13. Device according to claim 11, wherein the additional additive is not subject to a disclaimer, and
wherein the additive is subject to a disclaimer.

14. Device according to claim 10, further comprising at least one pump for delivering to the dispensing section the water, the flavor product, and the additive.

15. Device according to claim 10, wherein the flavor product, and the additive.

16. Device according to claim 14, wherein the containers carry readable data, and wherein the device comprises a reader, the control unit is configured to receive and use the readable data read for controlling that the container is positioned in a correct dispensing slot and is accurate for the preparation of a beverage and for controlling that the preparation of a beverage can be authorized.
